(19) United States
(12) Patent Application Publication
(10) Pub. No.: US 2021/0042363 A1
(43) Pub. Date: Feb. 11, 2021

(54) SEARCH PATTERN SUGGESTIONS FOR LARGE DATASETS

(71) Applicant: Capital One Services, LLC, McLean, VA (US)

(72) Inventors: Lokesh Vijay Kumar, Frisco, TX (US); Poornima Bagare RAJU, Frisco, TX (US)

(73) Assignee: Capital One Services, LLC, McLean, VA (US)

(21) Appl. No.: 16/536,645

(22) Filed: Aug. 9, 2019

(51) Int. Cl. G06F 16/9032; G06F 16/93; G06F 16/901

(52) U.S. Cl. CPC G06F 16/90324; G06N 5/04; G06F 16/9017; G06F 16/93

(57) ABSTRACT

Disclosed herein are system, method, and computer program product embodiments for performing phrase extraction on documents. A document may be broken down into fragments based on punctuation marks, and those fragments broken down into phrases based on stop-words. These phrases may be scored based on a frequency of appearance within the document, and the highest scoring phrases mapped to the document for search purposes. Those mapped phrases may also be used to provide suggestions for a search. Furthermore, phrases within a document may be scored against phrases across a set of documents to classify the document on the basis of these scores and a classification of documents that share similar phrase scores.

### BACKGROUND

When analyzing large documents and sets of documents, it is useful to be able to meaningfully search through those documents. Often, search functionality for such large sets of data can be rudimentary and based around keyword searches. These keyword searches often match search terms with documents based on a frequency at which the terms appear in the document.

Such searches may lead to identifying irrelevant documents simply on the basis that they contain many instances of the search term. Accordingly, approaches are needed to improve the relevance of documents returned in response to a search.

### BRIEF DESCRIPTION OF THE DRAWINGS

The accompanying drawings are incorporated herein and form a part of the specification.

FIG. 1 is a flowchart illustrating steps for performing phrase extraction on a document.

FIG. 2 is a flowchart illustrating steps for performing scoring, in accordance with an embodiment.

FIG. 3 is a search and suggestion architecture, in accordance with an embodiment.

FIG. 4 is a classification architecture, in accordance with an embodiment.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for facilitating searching and classification of large datasets.

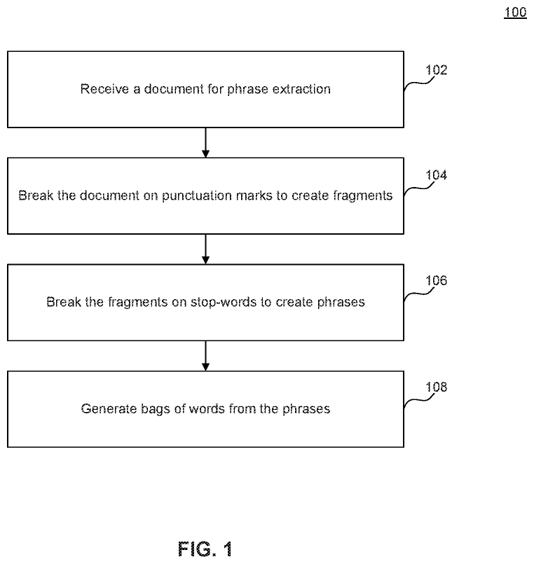

In order to provide facilities for search and classification of large datasets, phrase extraction is performed on a document. FIG. 1 is a flowchart 100 illustrating steps for performing phrase extraction on a document. At step 102, a document is received for performing phrase extraction. While a skilled artisan would appreciate that the document may be large, phrase extraction is explained herein with respect to a portion of text, which may be a portion of the larger document.

By way of a non-limiting example, phrase extraction is described with respect to the following sample text, as a stand-in for the document as a whole:
EOT calls not made. *Note* Findings below to be remediated under pre-existing issue 17195*How did this happen? Are there controls in place to capture this? If so, what controls are failing? Findings to be remediated:67 instances: Call attempts were not made every five business days to borrowers whose loans were 0-5 months prior to maturity. 3 instance: Call attempts were not made every fifteen business days to borrowers whose loans were 0-5 months prior to maturity (EZO).

In accordance with an embodiment, cleanup may be performed on the document before performing phrase extraction in order to improve results. For example, malformed dates, alphanumeric words, numbers, and punctuation may be identified and changed into a standard form that can be used as a proper basis of comparison. If some documents have dates written in the form “month/day/year” while others have dates written in the form “month day, year,” comparisons of those dates across documents may be improved through standardization.

At step 104, fragments are created based on breaking the document at punctuation marks. In the above example, characters such as a period, asterisk, question mark, comma, colon, dash, and the open and close parentheses are treated as punctuation marks. However, other characters (or fewer than these characters) may be handled as punctuation marks at this stage.

Based on these punctuation marks, the fragments created on the foregoing sample text would include: “EOT calls not made”, “Note”, “Findings below to be remediated under pre”, “existing issue 17195”, “How did this happen”, “Are there controls in place to capture this”, “If so”, “what controls are failing”, “Findings to be remediated”, “67 instances”, “Call attempts were not made every five business days to borrowers whose loans were 0”, “5 months prior to maturity”, “3 instance”, “Call attempts were not made every fifteen business days to borrowers whose loans were 0”, “5 months prior to maturity”, and “EZO”.

At step 106, the fragments are further broken down into phrases based on stop-words, in accordance with an embodiment. Stop-words are typically words that occur frequently and are typically filtered out before or after performing natural language processing on text. Standard libraries of stop-words may be used, or additional stop-words may be set or provided instead of or in addition to these standard libraries. In the foregoing example, stop-words include words such as “not”, “to”, “be”, “under”, “pre”, “how”, “did”, “this”, “happen”, “are”, “there”, “in”, “if”, “so”, “what”, “were”, “made”, and “every”.

Therefore, by breaking the above example fragments on such stop-word, phrases may be created that include “EOT calls”, “made”, “Note”, “Findings below”, “remediated”, “existing issue 17195”, “controls”, “capture”, “controls”, “failing”, “Findings”, “remediated”, “67 instances”, “Call attempts”, “five business days”, “borrowers whose loans”, “0”, “5 months prior”, “maturity”, “3 instance”, “Call attempts”, “fifteen business days”, “borrowers whose loans”, “0”, “5 months prior”, “maturity”, and “EZO”.

Next, at step 108, sub-phrases are created from the phrases—what are known as “bags of words.” These sub-phrases take each full phrase and break it down into sub-phrases ranging from 1 word to n words in size, where n is the number of words in the phrase. For example, the phrase “five business days” is broken down into sub-phrases where n=3: “five business days”; n=2: “five business” and “business days”; and n=1: “five”, “business”, and “days”. This is performed on other phrases obtained at step 106 as well.

The phrase extraction process of flowchart 100 undergirds the other embodiments disclosed herein, including document searching, search suggestions, and document classification. A skilled artisan would recognize that this phrase extraction process can be employed in other document analysis functions, and its use is not limited to these applications.

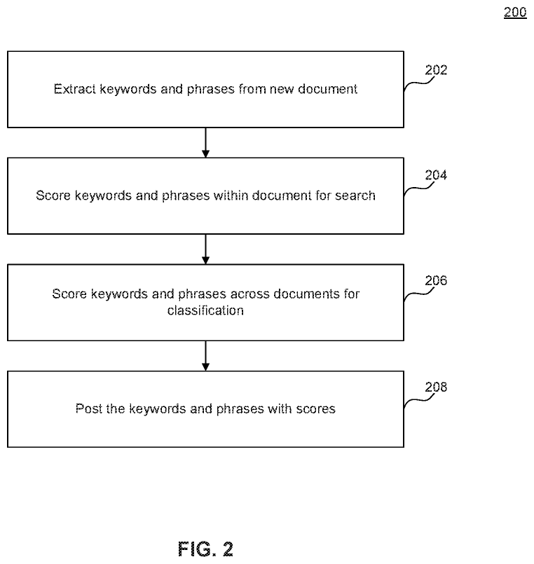

With phrases extracted from a document, scoring can be performed. FIG. 2 is a flowchart 200 illustrating steps for performing scoring, in accordance with an embodiment. At step 202, keywords and phrases are extracted from a document, in accordance with an embodiment. By way of non-limiting example, step 202 may be performed in accordance with the phrase extraction process of flowchart 100 of FIG. 1.

At step 204, keywords and phrases (referred to collectively as just “phrases”) within the document are scored for search purposes. By way of non-limiting example, phrases are scored within the document based on the frequency of each phrase within the document. A skilled artisan will appreciate that scoring may be performed in accordance with any number of additional mechanisms.

In accordance with a further embodiment, when a phrase is scored, that score is also used for sub-phrases of that phrase generated in accordance with a bag of words approach, as described above.

At step 206, phrases within the document are added to a matrix of phrases across a set of documents for classification, and scored across all of the set of documents in order to determine a classification for the document.

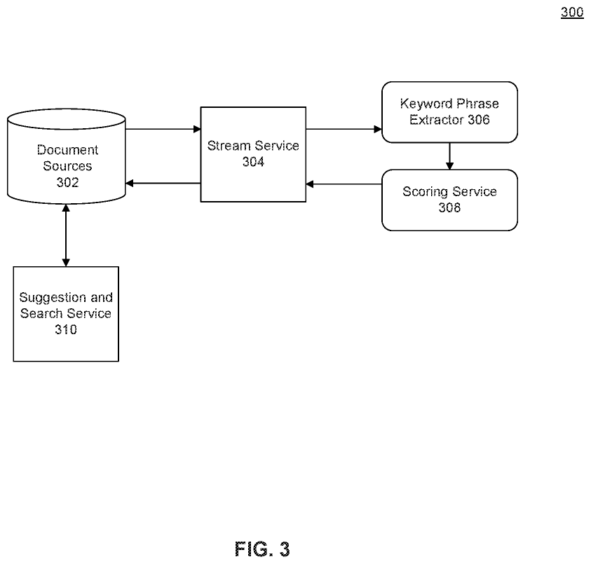

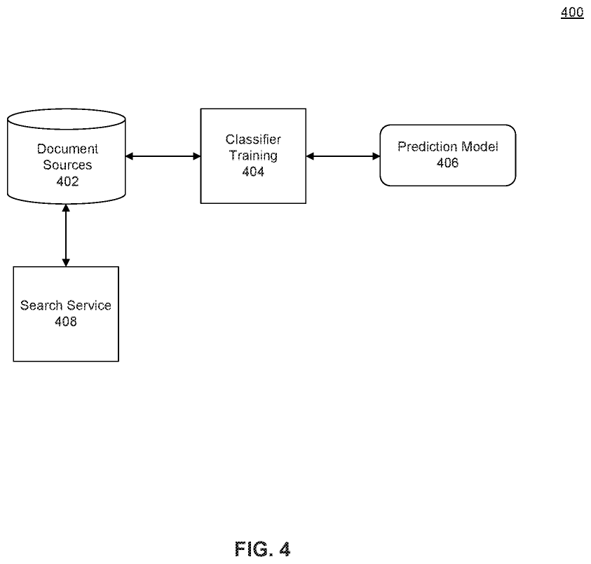

And, at step 208, the phrases are posted with their scores—specifically, the phrases are posted into data structures in memory based on their scores for use in search and/or classification. The use of scoring for search and classification is discussed in further detail below with respect to FIGS. 3 and 4.

FIG. 3 is a search and suggestion architecture 300, in accordance with an embodiment. By way of non-limiting example, components disclosed within search and suggestion architecture 300 may be located locally or remotely from other components, and may include implementation on a cloud-based service. Document sources 302 contain documents that can be searched, and for which search suggestions can be provided.

Stream service 304 is configured to read data from a document in document sources 302 and break the document into streams for processing at other services, in accordance with an embodiment. By way of non-limiting example, stream service 304 implements streams in accordance with available open source or commercial stream products, although a skilled artisan will appreciate that other streaming approaches may be used.

These streams are provided to keyword phrase extractor 306, in accordance with an embodiment. Keyword phrase extractor 306 is configured to extract keywords and phrases from the document in accordance with any extraction mechanism, but may be configured to do so in accordance with flowchart 100 of FIG. 1.

The extracted keywords and phrases are provided to scoring service 308, in accordance with an embodiment. Scoring service 308 performs scoring of the extracted keywords and phrases, such as a frequency-based scoring over the document. By way of non-limiting example, scoring service 308 performs scoring in accordance with the scoring for search process of step 204 of FIG. 2, but may be configured to perform scoring in accordance with any scoring mechanism. The results are handed back to document sources 302 (through stream service 304, in accordance with an embodiment) for storage.

Suggestion and search service 310 provides two separate functions, suggestion and search, into documents found in document sources 302. In accordance with an embodiment, suggestion and search service 310 may implement only a search service (without a suggestion service), or may implement a suggestion service (without a search service). These operations are described herein a separate functions, but regardless of whether one or both are implemented, they are serviced through the same suggestion and search service 310 component to a user.

Specifically, suggestion and search service 310 accesses memory structures (described further below) that allow for performing suggestion and search functionality on the basis of the highest scoring keywords and phrases for a given document stored in document sources 302, as processed by keyword phrase extractor 306 and scoring service 308.

Specifically, suggestion and search service 310 provides a user with a search field used for entering search terms, which are used by suggestion and search service 310 to identify documents in document sources 302 which the user may be interested in. This search field interfaces with a backend system that uses data structures that aid in locating candidate document search results from document sources 302. Specifically, if a user types in a search for “five business days” then any document that prominently features the phrase “five business days” (i.e., a document for which the phrase “five business days” scores above a threshold) should be presented to the user.

Additionally, suggestion and search service 310 provides the user with candidate searches as suggestions as they type characters into the search field. Specifically, if the phrase “five business days” scores highly across at least one document, then the phrase may be suggested as a candidate search to the user upon entry of less than all of the characters (e.g., entry of only “five busi” in the search field).

To facilitate a search for a phrase, suggestion and search service 310 (operating as a search service) may create a document reference map and store the same in a memory, in accordance with an embodiment. An example document reference map may read:

Document Reference Map

{

“Branded Card Mainstreet customers”: [

“DOC1”,
“DOC2”,
“DOC3”

],
“Branded Card”: [

“DOC1”,
“DOC2”,
“DOC3”,
“DOC5”

],
“Branded”:[

“DOC1”,
“DOC2”,
“DOC3”,
“DOC4”,
“DOC5”

]

}

By this exemplary document reference map, suggestion and search service 310 may take a search for “Branded Card Mainstreet customers” provided by a user in the search field and return three documents, DOC1, DOC2, and DOC3, as results. Similarly, a search for “Branded Card” would return DOC1, DOC2, DOC3, and DOC5 (it is a subset of the previous search). And a search for “Branded” would return all of those documents plus DOC4, which does not contain the phrases “Branded Card” or “Branded Card Mainstreet customers” as a sufficiently high-scoring phrase. A skilled artisan would recognize that the exact structure of the document reference map need not follow the above example, and that any appropriate mapping structure may be used instead.

The document reference map is constructed in this manner by suggestion and search service 310 by obtaining the highest scoring phrases from each document in document sources 302, in accordance with an embodiment. In accordance with a further embodiment, the highest scoring phrases are determined based on a score that is above a threshold. All of these highest scoring phrases across all documents are introduced as key values into the document reference map (e.g., “Branded Card Mainstreet customers”, “Branded Card”, and “Branded”, in the above example). And, for each key value, the documents that contributed that key value's highest scoring phrase as one of its highest scoring phrases is listed as a match.

Rather than requiring the user to type out the full phrase that matches a key value in the document reference map, however, suggestion and search service 310 would allow a user that types part of the phrase (e.g., “Br”) to select from possible suggestions (including, in this case, all three of the above key values). And, in accordance with an embodiment, one such suggestion may be pre-populated into the search field to simplify selection by the user of the same (e.g., by pressing the enter key once the suggestion is visible).

Continuing the above example, the suggestion functionality of suggestion and search service 310 is provided by placing the key values from the document reference map into a suggestions map, in accordance with an embodiment. An example suggestions map may read:

Suggestions Map

{

“keys”: [

“Branded Card Mainstreet customers”,
“Branded Card”,
“Branded”

]

}

A skilled artisan would recognize that the exact structure of the suggestions map need not follow the above example, and that any appropriate mapping structure may be used instead. In accordance with an embodiment, additional key values may be included that are derived from sub-phrases (e.g., other bag of words phrases) of phrases within the key values. Continuing the above example, key values may be inserted for “Mainstreet customers”, “customers”, and “Mainstreet” as well, for example.

In an embodiment, as the user enters characters into the search field, the backend system of suggestion and search service 310 limits the key values in the suggestions map to anything that begins with the characters in the search field. In an embodiment, suggestion and search service 310 may display possible key value matches as suggestions once the number of possible key value matches is below a threshold number of matches.

By selecting one of the displayed suggestions, the search field is modified to display the key value corresponding to the selected suggestion, and a search is performed on the key value, in accordance with an embodiment. This search is conducted against the document reference map, as described above, and provides documents matching the key value as a result.

By limiting phrases used as key values with a score threshold, key values in the document reference map will favor listing only those documents that feature the phrase corresponding to the key value most prominently. And, likewise, the size of the suggestions map will be limited by the presence of fewer (and more constructive) key values.

The document reference map and the suggestions map are stored in a memory accessible to the suggestion and search service 310. Although the sizes of these maps are controlled through the foregoing algorithms, the map sizes will be expected to grow as the pool of documents in document sources 302 grows. To improve performance of read access to these maps in conducting searches and providing suggestions, suggestion and search service 310 is configured to provide a map instance cluster, in accordance with an embodiment. In accordance with this embodiment, map instance cluster includes multiple memory instances, each with their own copy of either the document reference map, the suggestions map, or both. This permits multiple users to have their search and suggestion needs serviced by a memory instance with a lower load demand—for example, by having their search and suggestion processing directed to an appropriate memory instance using a load balancer.

In addition to using phrase extraction and scoring for searching and search suggestions, these processes may also be used for classification of a document, in accordance with an embodiment. FIG. 4 is a classification architecture 400, in accordance with an embodiment. Classification architecture 400 includes document sources 402, which is analogous to document sources 302 of FIG. 3 (and may be the same, in accordance with an embodiment in which both classification and search/suggestion functionality is provided).

Classification architecture 400 also includes search service 408, which provides a user with access to documents on the basis of their classification. In accordance with an embodiment, documents within document sources 402 are classified, and their classification stored with the corresponding document. A user may use this information to obtain documents from document sources 402 on the basis of the classifications, through search service 408 by way of non-limiting example. A skilled artisan will appreciate that any approach for organizing and visualizing documents in document sources 402 on the basis of their classification is contemplated within the scope of this disclosure, and search functionality is provided by way of non-limiting example.

Classifier training service 404 provides training to classify documents within document sources 402, in accordance with an embodiment. The result of this training is a prediction model 406. In an embodiment, prediction model 406 is first created by providing classifier training service 404 with documents from document sources 402 that correspond to each of various classifications. For example, a set of documents from document sources 402 (“Document Set A”) may be specified as documents that belong to a specific classification (“Classification A”). Likewise, other sets of documents may be specified as belonging to other classifications (e.g., Document Set B to Classification B, Document Set C to Classification C, etc.).

Classifier training service 404 uses these predefined relationships between document sets and classifications to define a relationship between each phrase within the document sets and the various classifications, in the form of prediction model 406, in accordance with an embodiment.

In an embodiment, prediction model 406 is structured such that every phrase (for example, every phrase obtained through the process of flowchart 100 of FIG. 1) in every document provided to classifier training service 404 from document sources 402 is scored against every phrase in a given document provided to classifier training service 404. By training prediction model 406 in this way, secondary phrases relevant to a classifier begin to emerge.

By way of a simple example, documents in Document Set A may all generally feature a phrase (Phrase A.1) as a high scoring phrase. Because those documents are classified under Classification A, it would be expected that any other document being tested against prediction model 406 that also features Phrase A.1 as a high scoring phrase should be classified under Classification A. However, other phrases may emerge in Document Set A (e.g., Phrase A.2) that score highly, and are likewise indicative of appropriate classification under Classification A. This would allow an additional document that features Phrase A.2 but not Phrase A.1 as a high scoring phrase to potentially also be classified under Classification A.

These patterns emerge because when Document Set A is provided to classifier training service 404, all of the phrases in all of the documents in Document Set A are used to generate scores in prediction model 406. Likewise, when Document Set B is provided to classifier training service 404, all of the phrases in all of the documents in both Document Sets A and B are used to generate scores in prediction model 406.

Below is an exemplary prediction model, such as prediction model 406, in accordance with an embodiment.

| | Phrase A | Phrase B | Phrase C | Phrase D | Classification |
|---|---|---|---|---|---|
| DOC1 | 50 | 0 | 35 | 0 | Class A |
| DOC2 | 0 | 50 | 10 | 0 | Class B |
| DOC3 | 0 | 0 | 0 | 50 | Class C |
| DOC4 | 0 | 0 | 50 | 0 | Class A |

In this example, prediction model 406 has been trained with documents DOC1, DOC2, and DOC3, and is being used to classify document DOC4.

DOC1 is provided to classifier training service 404 as an example of a Class A classification, DOC2 is provided as an example of Class B classification, and DOC3 is provided as an example of Class C classification.

DOC1 includes as phrases Phrase A and Phrase C. DOC2 includes as phrases Phrase B and Phrase C. And DOC3 includes as phrases Phrase D. Each document receives a score for each phrase it includes, in accordance with an embodiment. This scoring is performed against that phrase (e.g., using frequency based scoring, as discussed above) as it occurs in all of the documents. For example, although both DOC1 and DOC2 use the phrase Phrase C, DOC1's usage of the phrase can be compared to DOC2's usage of the phrase to determine that DOC1's usage scores higher (for example, if DOC1 uses Phrase C more than DOC2 does).

In this example, DOC4 is tested against prediction model 406 and is classified as Class A on the basis of its usage of Phrase C. This may be because, for example, DOC4 uses Phrase C frequently, even though it does not use Phrase A. If DOC1 was initially assigned to Class A for training purposes on the basis of the prevalence of Phrase A within the document, now a second order property in the frequency of Phrase C has emerged, and can be used to classify DOC4 appropriately.

In accordance with an embodiment, any new phrases in DOC4 are used by classifier training service 404 to expand prediction model 406—all new phrases are added to the prediction model 406 as further documents are classified.

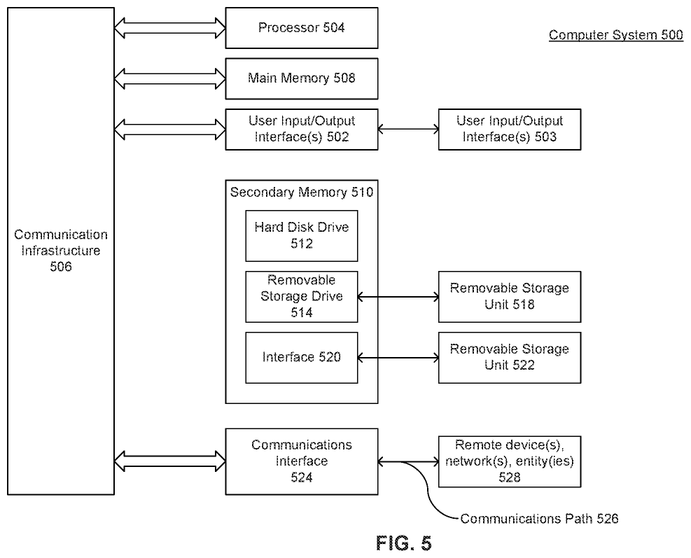

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer implemented method, comprising:
breaking, by one or more computing devices, a document on a punctuation mark to create a fragment;
breaking, by the one or more computing devices, the fragment on a stop-word to create a phrase filtering out the stop-word;
generating, by the one or more computing devices, a set of subphrases, wherein the set of subphrases comprises combinations of consecutive words of the phrase broken down into all individual subphrases that range in length from one word to the number of words in the phrase; and
mapping, by the one or more computing devices, the document to a subphrase of the set of subphrases having a highest frequency score in the document in a document map.

2. The computer implemented method of claim 1, further comprising:
storing, by the one or more computing devices, the document map in a memory instance;
storing, by the one or more computing devices, the subphrase as a key value of a suggestions map in the memory instance; and
suggesting, by the one or more computing devices, the subphrase from the suggestions map based on matching a character sequence from a search input to a character sequence of the subphrase.

3. The computer implemented method of claim 2, further comprising:
suggesting, by the one or more computing devices, the document from the document map when the search input matches the subphrase.

4. The computer implemented method of claim 2, wherein storing the document map in the memory instance comprises:
storing, by the one or more computing devices, the document map including a plurality of additional subphrases, wherein the additional subphrases are selected for storage based on a minimum frequency score.

5. The computer implemented method of claim 2, further comprising:
storing, by the one or more computing devices, the document map and the suggestions map in an additional memory instance,
wherein suggesting the subphrase from the suggestions map comprises obtaining the suggestions map from the memory instance or the additional memory instance based on a load of the memory instance and the additional memory instance.

6. The computer implemented method of claim 1, further comprising:
calculating, by the one or more computing devices, a frequency score of the subphrase based on a frequency of words in the subphrase.

7. The computer implemented method of claim 1, further comprising:
scoring, by the one or more computing devices, a frequency of the subphrase against subphrases of a first classification document and subphrases of a second classification document;
determining, by the one or more computing devices, that the frequency of the subphrase is higher relative to the first classification document than the second classification document; and
assigning, by the one or more computing devices, a classification of the first classification document to the document.

8. A system, comprising:
a memory configured to store operations; and
one or more processors configured to perform the operations, the operations comprising:
breaking a document on a punctuation mark to create a fragment,
breaking the fragment on a stop-word to create a phrase filtering out the stop-word,
generating a set of subphrases, wherein the set of subphrases comprises combinations of consecutive words of the phrase broken down into all individual subphrases that range in length from one word to the number of words in the phrase, and
mapping the document to a subphrase of the set of subphrases having a highest frequency score in the document in a document map.

9. The system of claim 8, the operations further comprising:
storing the document map in a memory instance;
storing the subphrase as a key value of a suggestions map in the memory instance; and
suggesting the subphrase from the suggestions map based on matching a character sequence from a search input to a character sequence of the subphrase.

10. The system of claim 9, the operations further comprising:
suggesting the document from the document map when the search input matches the subphrase.

11. The system of claim 9, wherein storing the document map in the memory instance comprises:
storing the document map including a plurality of additional subphrases, wherein the additional subphrases are selected for storage based on a minimum frequency score.

12. The system of claim 9, the operations further comprising:
storing the document map and the suggestions map in an additional memory instance,
wherein suggesting the subphrase from the suggestions map comprises obtaining the suggestions map from the memory instance or the additional memory instance based on a load of the memory instance and the additional memory instance.

13. The system of claim 8, the operations further comprising:
calculating a frequency score of the subphrase based on a frequency of words in the subphrase.

14. The system of claim 8, the operations further comprising:
scoring a frequency of the subphrase against subphrases of a first classification document and subphrases of a second classification document;
determining that the frequency of the subphrase is higher relative to the first classification document than the second classification document; and
assigning a classification of the first classification document to the document.

15. A computer readable storage device having instructions stored thereon, execution of which, by one or more processing devices, causes the one or more processing devices to perform operations comprising:
breaking a document on a punctuation mark to create a fragment;
breaking the fragment on a stop-word to create a phrase filtering out the stop-word;
generating a set of subphrases, wherein the set of subphrases comprises combinations of consecutive words of the phrase broken down into all individual subphrases that range in length from one word to the number of words in the phrase; and
mapping the document to a subphrase of the set of subphrases having a highest frequency score in the document in a document map.

16. The computer readable storage device of claim 15, the operations further comprising:
storing the document map in a memory instance;
storing the subphrase as a key value of a suggestions map in the memory instance; and
suggesting the subphrase from the suggestions map based on matching a character sequence from a search input to a character sequence of the subphrase.

17. The computer readable storage device of claim 16, the operations further comprising:
suggesting the document from the document map when the search input matches the subphrase.

18. The computer readable storage device of claim 16, wherein storing the document map in the memory instance comprises:
storing the document map including a plurality of additional subphrases, wherein the additional subphrases are selected for storage based on a minimum frequency score.

19. The computer readable storage device of claim 15, the operations further comprising:
calculating a frequency score of the subphrase based on a frequency of words in the subphrase.

20. The computer readable storage device of claim 15, the operations further comprising:
scoring a frequency of the subphrase against subphrases of a first classification document and subphrases of a second classification document;
determining that the frequency of the subphrase is higher relative to the first classification document than the second classification document; and
assigning a classification of the first classification document to the document.
